(19) United States
(12) Patent Application Publication
(10) Pub. No.: US 2024/0199951 A1
(43) Pub. Date: Jun. 20, 2024

(54) Fluorescent powder capable of promoting plant growth, and preparation method and use thereof

(71) Applicant: LANZHOU UNIVERSITY, Lanzhou, Gansu (CN)

(72) Inventors: Takatoshi SETO, Tsukuba City, Ibaraki Prefecture (JP); Yuhua WANG, Lanzhou, Gansu (CN); Ziyong KANG, Lanzhou, Gansu (CN)

(21) Appl. No.: 18/287,032

(22) PCT Filed: Apr. 15, 2022
(86) PCT No.: PCT/CN2022/087229

§ 371 Date: Dec. 18, 2023

(30) Foreign Application Priority Data
Apr. 16, 2021 (CN) 202110409308.1

(51) Int. Cl. C09K 11/77; A01G 7/06; A01G 22/05; C01B 25/455; C09K 11/02

(52) U.S. Cl. CPC C09K 11/7737; A01G 7/06; A01G 22/05; C01B 25/455; C09K 11/02; C01P 2002/54; C01P 2002/72; C01P 2004/03; C01P 2006/60

(57) ABSTRACT

The present disclosure disclosed a fluorescent powder capable of promoting plant growth and preparation and use thereof. The fluorescent powder is formed by doping Ee²⁺ in a halophosphate containing Rb⁺, and has a crystal structure of Prima and a chemical formula of Rb_{y}K_{2-y}CaPO₄F:yEu²⁺ The fluorescent powder is prepared by high temperature solid-state method, emits red light beneficial to plant growth under irradiation of an ultraviolet lamp or light in an ultraviolet light region to a blue light region of sunlight, can improve the utilization rate of light energy, promotes plant growth, and has a low cost, no pollution, high efficiency and no consumption of electric energy.

This application is based on Chinese Patent Application No. 202110409308.1, filed Apr. 16, 2021, which claims the benefit of priority to the Chinese Patent Application, which is incorporated by reference in its entirety herein.

### TECHNICAL FIELD

The present disclosure belongs to the technical field of solid luminescent materials, and relates to a red luminescent material, in particular to a fluorescent powder capable of promoting plant growth that emits a red light under irradiation of an ultraviolet lamp or sunlight. The present disclosure further relates to a preparation method and use of the fluorescent powder.

### BACKGROUND

Carbohydrates are synthesized by photosynthesis of plants with pigments to serve as basic nutrients for growth of the plants, and light provides energy for the plants during germination and fruit ripening. Thus, light regulation is one of important means to regulate plant growth. It has found through research that the plants mainly absorb light by chlorophyll and phytochrome. The chlorophyll mainly absorbs blue light (400 nm to 500 nm) and orange-red light (600 nm to 700 nm), and the phytochrome absorbs red light and light in a dark red (650 nm to 750 nmnm) region, corresponding to phototropism, photosynthesis and photomorphogenesis, respectively. The light located in the red light region (600 nm to 700 nm) is the most important light for plant growth, because the red light has a great impact on developing and ripening stages of the plants. In addition, the plants rarely absorb other ranges of light in sunlight, and the plants get small red light during growth, so that the utilization rate of sunlight is extremely low. In addition, a red light part of the sunlight is weaker than a blue light part. Therefore, improvement of the utilization rate of light by the plants has a crucial impact on plant growth, and improvement of the utilization rate of light energy by the plants can greatly increase the growth rate of the plants and increase the yield. Until now, light-emitting diode (LED) plant lamps are mostly used for cultivation of plants. However, due to narrow spectral curves or spectral curves not satisfying absorption of plants during photosynthesis and a low utilization rate of light source energy, many plant lamps are not suitable for plant growth. In addition, as LED chips have high price and consume electricity, the planting cost is increased indirectly, and promotion in a large scale is difficult. Therefore, it is necessary to develop a novel fluorescent powder material that is low in price and capable of improving the utilization rate of solar radiation energy by plants.

### SUMMARY

An objective of the present disclosure is to provide a fluorescent powder capable of promoting plant growth, so as to meet demands for plant growth.

Another objective of the present disclosure is to provide a method for preparing the fluorescent powder.

A third objective of the present disclosure is to provide a use of the fluorescent powder.

In order to realize the above objectives, a technical scheme adopted by the present disclosure is: a fluorescent powder capable of promoting plant growth. The fluorescent powder is formed by doping Eu²⁺ in a halophosphate containing Rb⁺, and has a crystal structure of Prima. The fluorescent powder is prepared by doping Eu²⁺ in Rb_{y}K_{2-y}CaPO₄F, where y is greater than 0 and equal to or less than 0.6.

The fluorescent powder has a chemical zonula of Rb_{y}K_{2-y}CaPO₄F:yEu²⁺, where y is greater than 0 and equal to or less than 0.6, and preferably, the y is equal to or greater than 0.2 and equal to or less than 0.4.

Another technical scheme adopted by the present disclosure is: a method for preparing the fluorescent powder. The method specifically includes the following steps:
step 1: weigh various raw materials according to a stoichiometric ratio of various chemical components in the chemical formula Rb_{y}K_{2-y}CaPO₄F:yEu²⁺, respectively, where the various raw materials are compounds of the various chemical components;
where a rubidium compound includes rubidium carbonate (Rb₂CO₃), hydroxide of rubidium, nitrate of rubidium, carbonate of rubidium, sulfate of rubidium or phosphate of rubidium;
a potassium compound includes potassium carbonate (K₂CO₃), hydroxide of potassium, nitrate of potassium, sulfate of potassium or phosphate of potassium;
a calcium compound includes calcium carbonate (CaCO₃), hydroxide of calcium, nitrate of calcium, sulfate of calcium or phosphate of calcium;
a phosphorus compound includes ammonium dihydrogen phosphate (NH₄H₂PO₄) or hydroxide of phosphorus;
a fluorine compound includes potassium fluoride (KF), hydroxide of fluorine, nitrate of fluorine, carbonate containing fluorine, sulfate of fluorine or phosphate of fluorine;
and a europium compound includes europium oxide (Eu₂O₃), hydroxide of europium, nitrate of europium, carbonate of europium, sulfate of europium or phosphate of europium;
grind the weighed raw materials to micron level, and mix uniformly to obtain a raw material powder; and
step 2: place the raw material powder in an environment with a reducing atmosphere introduced therein, calcine the raw material powder for 4 hours after raise the temperature to 850° C. with a heating rate of 5° C./min to obtain a calcined product, naturally cool the calcined product to room temperature, and then grind the calcined product to obtain the fluorescent powder capable of promote plant growth.

The reducing atmosphere may include three gases: the first one is an ammonia gas (NH₃), the second one is a mixed gas composed of 5% to 25% of hydrogen (H₂) and 95% to 75% of nitrogen (N₂) by volume percentage, and the third one is a mixed gas composed of 5% to 25% of carbon monoxide (CO) and 95% to 75% of nitrogen (N₂) by volume percentage.

A third technical scheme adopted by the present disclosure is: a use of the fluorescent powder in promoting plant growth, namely, the use in promoting growth of tomatoes and growth of chlorellas. When used in promoting growth of tomatoes, the fluorescent powder is prepared into a light conversion film by a preparation method in the prior art, at least two light conversion films are placed at bottoms of tomato plants, the at least two light conversion films are evenly arranged around the tomato plants, and an intersect angle between the light conversion film and the horizontal plane is 0° to 60°, preferably 20° to 60°. When the light conversion film is placed parallel to the horizontal line (that is to say, the intersect angle between the light conversion film and the horizontal plane is 00), leaves of the plants block the upper sunlight from reaching the light conversion film. Meanwhile, in a case that the light conversion film is highly inclined at an angle of 900 from the horizontal line, the amount of light irradiated from the upper sunlight to the light conversion film is quite small. Therefore, the optimal angle is 200 to 60°.

The fluorescent powder of the present disclosure is prepared by high temperature solid-state method, and has the advantages of a simple process, no pollution, no generation of any harmful substances, a green effect, environmental friendliness and a low cost. The fluorescent powder has an excitation spectrum in a wide coverage area, can absorb light in an ultraviolet light region to a blue light region of sunlight, has high emission intensity in a red light region, and can improve the utilization rate of light energy, which is more conducive to promoting plant growth. The fluorescent powder has strong luminous ability, high efficiency and no consumption of electric energy.

### BRIEF DESCRIPTION OF THE DRAWINGS

FIG. 1 shows comparison between an X-ray diffraction (XRD) pattern of a fluorescent powder prepared in Example 1 and a standard card.

FIG. 2 shows an excitation spectrum and an emission spectrum of the fluorescent powder prepared in Example 1.

FIG. 3 shows a scanning electron microscope image of the fluorescent powder prepared in Example 1.

FIG. 4 shows comparison between XRD patterns of fluorescent powders prepared in Examples 1-6 and a standard card.

FIG. 5 shows comparison between emission spectra of the fluorescent powders prepared in Examples 1-6.

FIG. 6 shows comparison between emission spectra of fluorescent powders prepared in Examples 7-13 and a fluorescent powder prepared in Comparative Example.

FIG. 7 shows comparison between excitation spectra of the fluorescent powders prepared in Examples 7-13 and the fluorescent powder prepared in Comparative Example.

FIG. 8 shows solar spectrum.

FIG. 9 shows an emission spectrum and an excitation spectrum of the fluorescent powder prepared in Example 1.

FIG. 10 shows absorption spectra of chlorophyll a and chlorophyll b.

FIG. 11 shows an experiment of promoting growth of chlorellas by using light conversion films.

FIG. 12 shows optical density (OD) value change curves of chlorellas after growth promoted by using light conversion films within one cycle (7 days).

FIG. 13 shows transmission of a light conversion film and reflection of a combination of the light conversion film and a lining plate.

FIG. 14 shows a tomato growth experiment.

FIG. 15 shows comparison of the ripeness of tomato fruits obtained in the tomato growth experiment.

### DETAILED DESCRIPTION OF THE EMBODIMENTS

The present disclosure is described in detail below in combination with accompanying drawings and specific embodiments.

### Example 1

0.3464 g Rb₂CO₃, 0.8292 g K₂CO₃, 1.4850 g CaCO₃, 1.7255 g NH₄H₂PO₄, 0.9587 g KF and 0.02640 g Eu₂O₃ were weighed according to a stoichiometric ratio shown in a molecular formula Rb_{0.2}K_{1.8}CaPO₄F:0.02Eu. The weighed raw materials were fully ground, mixed uniformly, placed in an alumina crucible and put into a tube furnace, and a reducing atmosphere composed of 5% of H₂ and 95% of N₂ by volume percentage was introduced. Then, a resulting mixture was calcined for 4 hours after the temperature was raised to 850° C. with a heating rate of 5° C./min to obtain a calcined product, and the calcined product was cooled to room temperature with the furnace and then ground to obtain a fluorescent powder capable of promoting plant growth.

### Example 2

Rb₂CO₃, K₂CO₃, CaCO₃, NH₄H₂PO₄, KF and Eu₂O₃ were weighed according to a stoichiometric ratio shown in a chemical formula Rb_{0.1}K_{1.9}CaPO₄F:0.1Eu. A fluorescent powder capable of promoting plant growth was prepared by the method in Example 1.

### Example 3

Rb₂CO₃, K₂CO₃, CaCO₃, NH₄H₂PO₄, KF and Eu₂O₃ were weighed according to a stoichiometric ratio shown in a chemical formula Rb_{0.01}K_{1.99}CaPO₄F:0.01Eu. A fluorescent powder capable of promoting plant growth was prepared by the method in Example 1.

### Example 4

Rb₂CO₃, K₂CO₃, CaCO₃, NH₄H₂PO₄, KF and Eu₂O₃ were weighed according to a stoichiometric ratio shown in a chemical formula Rb_{0.55}K_{1.45}CaPO₄F:0.55Eu. A fluorescent powder capable of promoting plant growth was prepared by the method in Example 1.

### Example 5

Rb₂CO₃, K₂CO₃, CaCO₃, NH₄H₂PO₄, KF and Eu₂O₃ were weighed according to a stoichiometric ratio shown in a chemical formula Rb_{0.3}K_{1.7}CaPO₄F:0.3Eu. A fluorescent powder capable of promoting plant growth was prepared by the method in Example 1.

### Example 6

Rb₂CO₃, K₂CO₃, CaCO₃, NH₄H₂PO₄, KF and Eu₂O₃ were weighed according to a stoichiometric ratio shown in a chemical formula Rb_{0.05}K_{1.5}CaPO₄F:0.5Eu. A fluorescent powder capable of promoting plant growth was prepared by the method in Example 1.

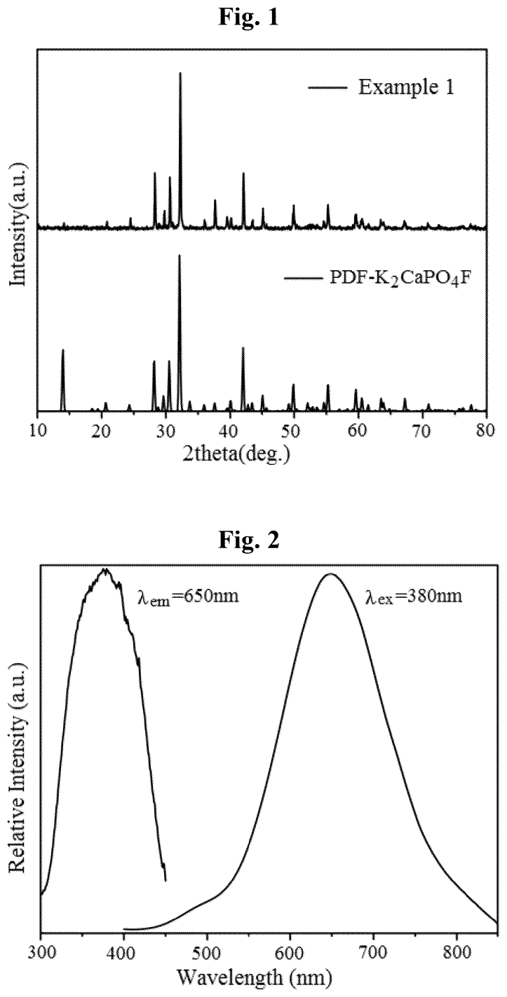

An XRD pattern of the fluorescent powder prepared in Example 1 was shown in FIG. 1. The shape and position of each peak in the figure corresponded to those in a PDF card one by one, proving that the phase of the prepared powder was single phase.

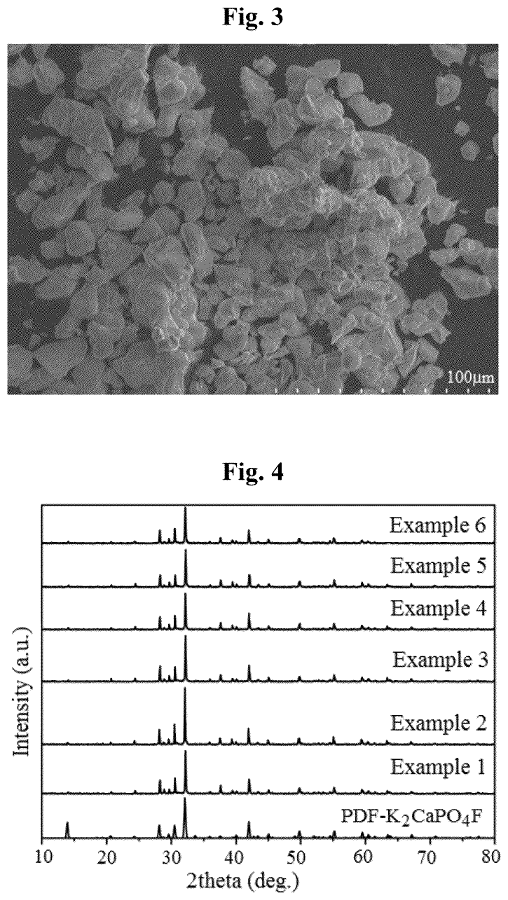

An excitation spectrum and an emission spectrum of the fluorescent powder prepared in Example 1 were shown in FIG. 2. The excitation spectrum shows a wide absorption spectrum (300 nm to 450 nm), and an excitation peak had a peak value at 380 nm. The emission spectrum shows a wide emission peak having a peak value at 650 nm. It can be found by the spectrogram that the Rb₀₂K_{1.8}CaPO₄F:0.02Eu had absorption in an ultraviolet light region of 300 nm to 380 nm, so that damage caused by ultraviolet light in sunlight to plants was avoided. FIG. 3 shows a scanning electron microscope image of the fluorescent powder prepared in Example 1. It can be seen from the figure that particle size of the fluorescent powder was above 10 μm and uniform particle distribution, indicating that the fluorescent powder had good crystallinity.

XRD patterns of the fluorescent powders prepared in Examples 1-6 were shown in FIG. 4. The shape and position of each peak in the figure corresponded to those in a PDF card one by one, proving that the phase of the fluorescent powders prepared in Examples 1-6 were single phase.

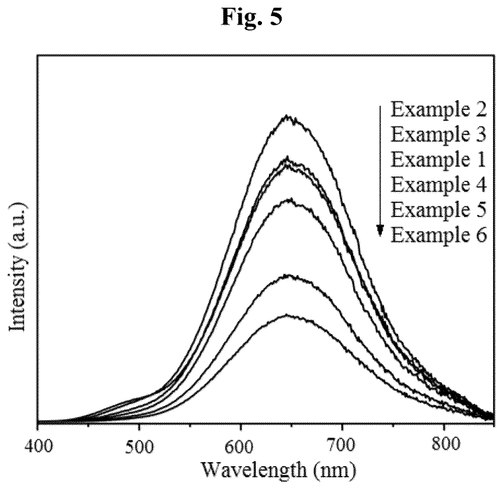

Emission spectra of the fluorescent powders prepared in Examples 1-6 were shown in FIG. 5. It can be seen from the figure that fluorescent powder prepared in Example 2 had the highest luminous intensity and emitted strongest orange-red light, which can provide stronger red light for plants.

### Example 7

Rb₂CO₃, K₂CO₃, CaCO₃, NH₄H₂PO₄, KF and Eu₂O₃ were weighed according to a stoichiometric ratio shown in a chemical formula Rb_{0.2S}K_{1.75}CaPO₄F:0.25Eu. The weighed raw materials were ground to micron level and mixed uniformly to obtain a raw material powder. The raw material powder was placed in an environment with an ammonia gas introduced therein, and calcined for 4 hours after the temperature was raised to 850° C. with a heating rate of 5° C./min to obtain a calcined product. Then, the calcined product was cooled to room temperature naturally and ground to obtain a fluorescent powder capable of promoting plant growth.

### Example 8

Rb₂CO₃, K₂CO₃, CaCO₃, NH₄H₂PO₄, KF and Eu₂O₃ were weighed according to a stoichiometric ratio shown in a chemical formula Rb_{0.4}K_{1.6}CaPO₄F:0.4Eu. The weighed raw materials were ground to micron level and mixed uniformly to obtain a raw material powder. The raw material powder was placed in an environment with a reducing atmosphere composed of 25% of carbon monoxide and 75% of nitrogen by volume percentage introduced therein, and calcined for 4 hours after the temperature was raised to 850° C. with a heating rate of 5° C./min to obtain a calcined product. Then, the calcined product was cooled naturally to room temperature and ground to obtain a fluorescent powder.

### Example 9

Rb₂CO₃, K₂CO₃, CaCO₃, NH₄H₂PO₄, KF and Eu₂O₃ were weighed according to a stoichiometric ratio shown in a chemical formula Rb_{0.6}K_{1.4}PO₄F:0.6Eu. The weighed raw materials were ground to micron level and mixed uniformly to obtain a raw material powder. The raw material powder was placed in an environment with a reducing atmosphere composed of 5% of carbon monoxide and 95% of nitrogen by volume percentage introduced therein, and calcined for 4 hours after the temperature was raised to 850° C. with a heating rate of 5° C. min to obtain a calcined product. Then, the calcined product was cooled naturally to room temperature and ground to obtain a fluorescent powder.

### Example 10

Rb₂CO₃, K₂CO₃, CaCO₃, NH₄H₂PO₄, KF and Eu₂O₃ were weighed according to a stoichiometric ratio shown in a chemical formula Rb_{0.005}K_{1.995}CaPO₄F:0.005Eu. The weighed raw materials were ground to micron level and mixed uniformly to obtain a raw material powder. The raw material powder was placed in an environment with a reducing atmosphere composed of 25% of hydrogen and 75% of nitrogen by volume percentage introduced therein, and calcined for 4 hours after the temperature was raised to 850° C. with a heating rate of 5° C./min to obtain a calcined product. Then, the calcined product was cooled naturally to room temperature and ground to obtain a fluorescent powder.

### Example 11

Rb₂CO₃, K₂CO₃, CaCO₃, NH₄H₂PO₄, KF and Eu₂O₃ were weighed according to a stoichiometric ratio shown in a chemical formula Rb_{0.15}K_{1.88}CaPO₄F:0.15Eu. A fluorescent powder was prepared by the method in Example 7.

### Example 12

Rb₂CO₃, K₂CO₃, CaCO₃, NH₄H₂PO₄, KF and Eu₂O₃ were weighed according to a stoichiometric ratio shown in a chemical formula Rb_{0.001}K_{1.999}CaPO₄F:0.001Eu. A fluorescent powder was prepared by the method in Example 8.

### Example 13

Rb₂CO₃, CaCO₃, NH₄H₂PO₄, KF and Eu₂O₃ were weighed according to a stoichiometric ratio shown in a chemical formula Rb_{0.35}K_{1.65}CaPO₄F:0.35Eu. A fluorescent powder was prepared by the method in Example 9.

### Comparative Example

A fluorescent powder (K₂CaPO₄F:Eu) in the prior art was selected.

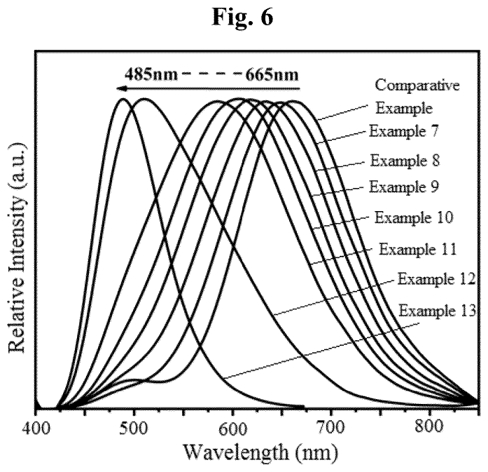

The fluorescent powder (K₂CaPO₄F:Eu) in Comparative Example has a dark red emission under irradiation of an LED excited by near ultraviolet light (NUV) (H. Daicho et al., Chem. Commun., 54 (2018) 884.). However, the fluorescent powder (K₂CaPO₄F:Eu) has a too long emission wavelength (610 nm to 750 nm), which not only leads to loss of LED irradiation energy, but also leads to loss of plant growth energy. In order to solve the problems of the prior art, Rb was doped in the fluorescent powder (K₂CaPO₄F:Eu) and Rb⁺ was used to replace K⁺¹ site in the present disclosure, so that the crystal field intensity and the Stokes shift became small, and the emission of the fluorescent powder obviously moved to a shorter wavelength without changing an excitation wavelength, as shown in FIG. 6 (λ_{eX}=380 nm) and FIG. 7 (λₑₘ referd to a wavelength of each peak in FIG. 6). Based on such Stokes shift, the emission wavelength of the fluorescent powder can be adjusted to a most suitable range of 600 nm to 720 nm, so as to facilitate growth of plants under NUV and light blue sunlight.

The fluorescent powders prepared by using and designing different raw materials based on the preparation method of the present disclosure have similar properties and technical effects.

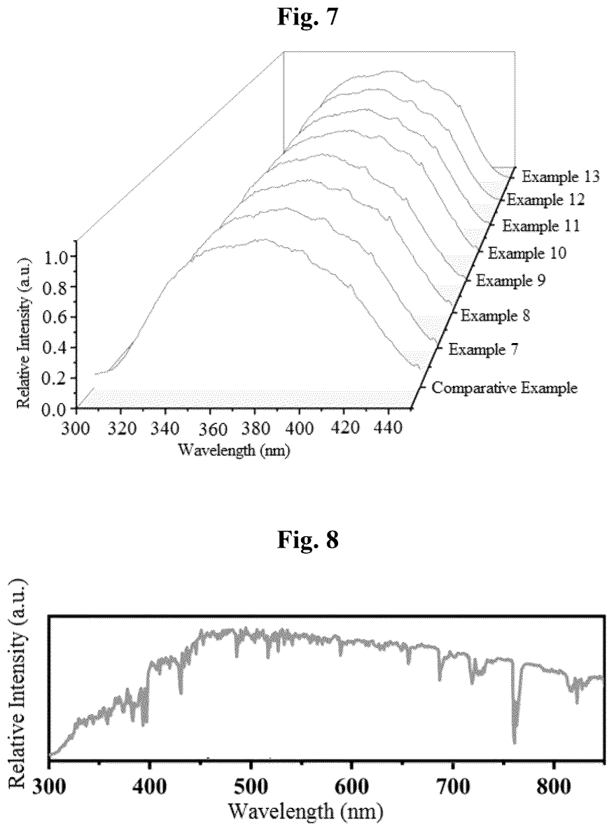

Solar spectrum is shown in FIG. 8. It can be seen from FIG. 8 that a blue light part of the spectrum of sunlight was the strongest, which can well satisfy a blue light absorption part of chlorophyll.

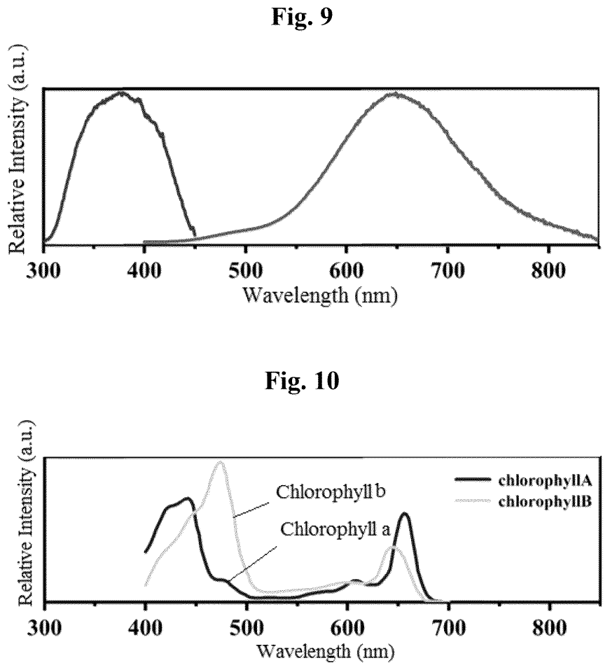

Based on regulation of luminescence properties, a novel red fluorescent powder (Rb_{0.2}K_{1.8}CaPO₄F:0.02Eu²⁺) with excellent luminescence properties was successfully prepared in the present disclosure. It can be seen from FIG. 9 and FIG. 10 that the Rb_{0.2}K_{1.8}CaPO₄F:0.02Eu²⁺ had a large emission spectrum half-peak width, which covered an absorption spectrum of plant chlorophyll in a red light region, and had an excitation peak located in an ultraviolet light region, which can effectively avoid damage caused by ultraviolet light to plants. Therefore, a light conversion film prepared from the fluorescent powder (Rb_{0.2}K_{1.8}CaPO₄F:0.02Eu²⁺) of the present disclosure can be excited by sunlight outdoors to emit red light capable of promoting plant growth.

Based on the above theoretical analysis, a chlorella growth experiment and a tomato growth experiment were carried out.

### 1. Growth Experiments of Chlorella

As one of green unicellular algae, chlorellas have become a hot spot in biological cultivation in recent years. Different from traditional land cultivation, the chlorellas grow and reproduce in a water environment and are applicable to growth in an alkaline environment with full sunlight at a temperature of about 30° C. The chlorellas grow in a cell division mode, thus having a high reproduction rate. The chlorellas contain more chloroplasts, and light plays a decisive role on growth of the chlorellas. Most plants have long growth cycles, while the chlorellas usually have a cultivation cycle of 7 days, so that convenience is provided to carry out a growth experiment, and several experiments can be carried out in a short period of time. CO₂ is introduced continuously in a cultivation process.

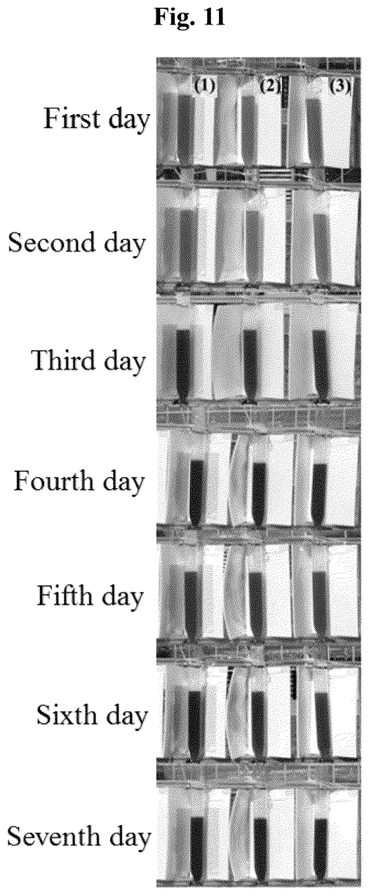

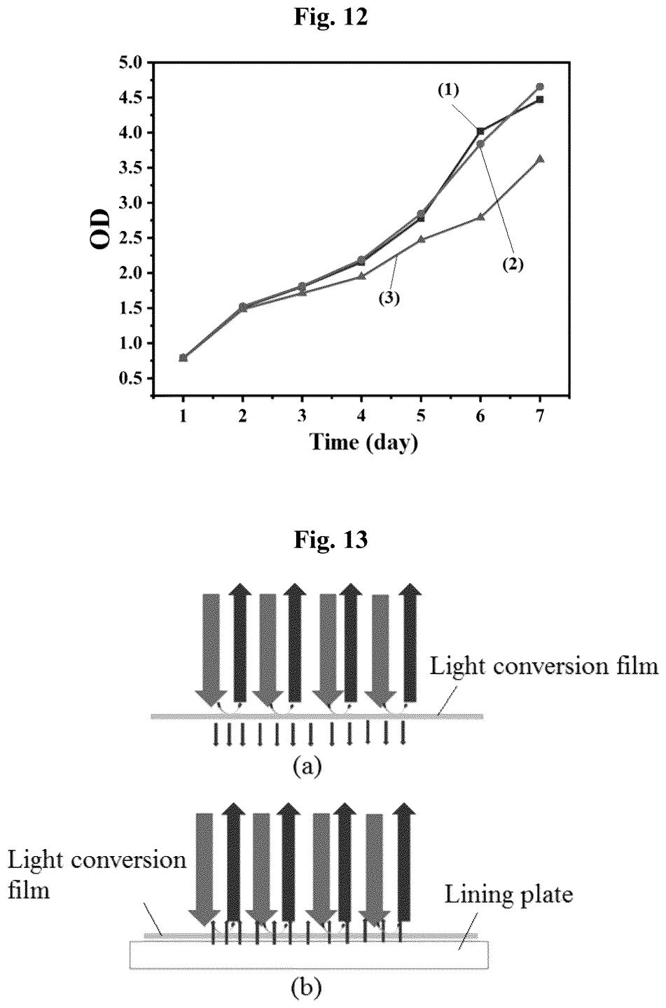

An experiment of promoting growth of chlorellas by using light conversion films was carried out. A Teflon plate was used as a support frame of the light conversion films, so that an intersect angle between the two films was 90°. A glass tube loaded with chlorellas was located between the two light conversion films, as shown in FIG. 11. In FIG. 11, number (1) refers to a group using a light conversion film prepared from a commercial fluorescent powder (Sr₂Si₅Ns:Eu²⁺) and polydimethylsiloxane (PDMS) (the mass percentage of the fluorescent powder in the light conversion film was 20%). Number (2) refers to a group using a light conversion film prepared from a fluorescent powder (Rb_{0.2}K_{1.8}CaPO₄F:Eu²⁺) of the present disclosure, where the mass percentage of the fluorescent powder in the light conversion film was 20%. Number (3) referred to a blank control group. It can be clearly seen from FIG. 11 that the concentration of chlorellas in the glass tube was continuously increased as time goes by. FIG. 12 shows an OD value (optical density) of chlorellas measured every day after a growth experiment within one cycle (7 days). The initial OD value was 0.5131 g and then increased in multiples. On the seventh day, it can be seen that the group (2) had an optimal result of 4.6551 g in the experiment of promoting growth of chlorellas by using light conversion films. The OD value of the chlorellas in the group (2) was increased by 28% compared with 3.6171 g in the blank control group (3), followed by 25% of the OD value of the group (1) using the commercial fluorescent powder (Sr₂Si₅N₈:Eu²⁺). The experimental results showed that the light conversion film prepared from the fluorescent powder of the present disclosure had certain efficiency in promoting growth of chlorellas.

### 2. Growth Experiments of Tomato

No matter transmission type light conversion films or reflection type light conversion films had light loss due to reflection, transmission, or refraction of partial light (as shown in FIG. 13a). A reflection type light conversion film was used in the present disclosure. In order to reduce decrease of conversion efficiency caused by transmission of partial light, a lining plate behind the light conversion film was required to be used to reflect the transmitted light again (as shown in FIG. 13b). The lining plate not only needs to have good plasticity and can fit with the film conversion film, but also needs to be prepared from a smooth white material to ensure that the transmitted light is completely reflected back. A Teflon plate was used as the lining plate for the light conversion film in the present disclosure. When blue light in the sunlight irradiated on the light conversion film is converted into red light required by plants, a part of the red light was reflected on the plants, while another part of the red light was transmitted through the light conversion film and is then lost. After a Teflon lining plate was installed behind the light conversion film, some of the transmitted red light was refracted and reflected back to the plants again, thereby further improving the light conversion efficiency.

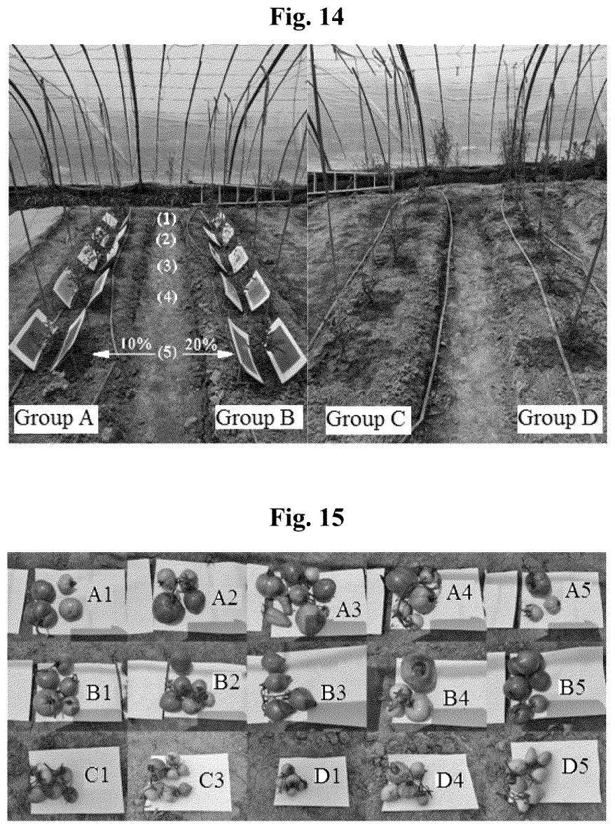

FIG. 14 shows an experiment of cultivating tomato growth by using light conversion films. The mass percentage of a fluorescent powder in a light conversion film of Group A was 10%, the mass percentage of a fluorescent powder in a light conversion film of Group B was 20%, light conversion films prepared from a fluorescent powder (Rb_{0.2}K_{1.8}CaPO₄F:Eu²⁺) of the present disclosure were used for two tomato plants (A1 and B1) corresponding to number (2) in FIG. 14, and light conversion films prepared from other commercial fluorescent powders were used for other numbers. Group C and Group D were set as control groups. The reason for setting two control groups was that the accuracy of experimental data was verified with multiple comparison objects in a case of the occurrence of dead seedlings. Two light conversion films were placed at bottoms of tomato plants, the two light conversion films were placed on two sides of the tomato plants, respectively, and an intersect angle between the light conversion film and the horizontal plane was 0° to 60°, preferably 20° to 60°. After growth for three months or above, ripening situations of tomato fruits of Group A, Group B, Group C and Group D are shown in FIG. 15. Four tomato seedlings in the control groups died during the experiment, one tomato seedling had no fruits, and only five seedlings had fruits in the control groups. It can be clearly found from the figure that most of tomatoes produced by tomato seedlings in experimental groups were ripe, while almost all of tomato seedlings in the control groups were not ripe. The weight of fruits irradiated using the light conversion film prepared from the fluorescent powder (Rb_{0.2}K_{1.8}CaPO₄F:Eu²⁺) of the present disclosure is increased by 27% compared with the average weight of fruits in the control groups. Based on the above experimental results and analysis, it is shown that the experiments of cultivating tomatoes by using light conversion films can achieve the effects of ripening fruits in advance and increasing the yield.

According to the experimental results of promoting growth of chlorellas and tomatoes by using light conversion films, it can be concluded that the light conversion film synthesized by using the fluorescent powder (Rb_{0.2}K_{1.8}CaPO₄F:Eu²⁺) of the present disclosure and polydimethylsiloxane (PDMS) can increase the yield and ripen plants in advance. Therefore, the light conversion film prepared from the fluorescent powder of the present disclosure has an efficient effect on promoting plant growth, and the light conversion film has market application potential.

1. A fluorescent powder capable of promoting plant growth, wherein the fluorescent powder is a halophosphate containing Rb⁺ excited by Eu²⁺ and has a crystal structure of Prima.

2. The fluorescent powder capable of promoting plant growth according to claim 1, wherein the fluorescent powder is prepared by doping Eu²⁺ in Rb_{y}K_{2-y}CaPO₄F, and y is greater than 0 and equal to or less than 0.6.

3. The fluorescent powder capable of promoting plant growth according to claim 2, wherein a chemical formula of the prepared fluorescent powder is Rb_{y}K_{2-y}CaPO₄F:yEu²⁺, and y is equal to or greater than 0.2 and equal to or less than 0.4.

4. The fluorescent powder capable of promoting plant growth according to claim 1, wherein when the fluorescent powder is used, the fluorescent powder is prepared into a light conversion film with resin, a reflection film is arranged below the light conversion film, and a system composed of the reflection film and the light conversion film is capable of converting sunlight into red light.

5. A method for preparing the fluorescent powder capable of promoting plant growth according to claim 1, wherein the method specifically comprising the following steps:
step 1: weighing various raw materials according to a stoichiometric ratio of the various chemical components in the chemical formula Rb_{y}K_{2-y}CaPO₄F:yEu²⁺, respectively, grinding the weighed raw materials to micron level, and mixing uniformly to obtain a raw material powder, and
step 2: placing the raw material powder in an environment with a reducing atmosphere introduced therein, calcining the raw material powder for 4 hours after raising the temperature to 850° C. with a heating rate of 5° C./min to obtain a calcined product, cooling the calcined product to room temperature naturally, and then grinding the calcined product to obtain the fluorescent powder capable of promoting plant growth.

6. The method for preparing the fluorescent powder capable of promoting plant growth according to claim 5, wherein in step 1, the various raw materials comprising a rubidium compound, a potassium compound, a calcium compound, a phosphorus compound, a fluorine compound and a europium compound, respectively.

7. The method for preparing the fluorescent powder capable of promoting plant growth according to claim 6, wherein the rubidium compound comprising rubidium carbonate, hydroxide of rubidium, nitrate of rubidium, carbonate of rubidium, sulfate of rubidium or phosphate of rubidium;
the potassium compound comprising potassium carbonate, hydroxide of potassium, nitrate of potassium, sulfate of potassium or phosphate of potassium;
the calcium compound comprising calcium carbonate, hydroxide of calcium, nitrate of calcium, sulfate of calcium or phosphate of calcium;
the phosphorus compound comprising ammonium dihydrogen phosphate or hydroxide of phosphorus;
the fluorine compound comprising potassium fluoride, hydroxide of fluorine, nitrate of fluorine, carbonate of fluorine, sulfate of fluorine or phosphate of fluorine;
and the europium compound comprising europium oxide, hydroxide of europium, nitrate of europium, carbonate of europium, sulfate of europium or phosphate of europium.

8. Use of the fluorescent powder capable of promoting plant growth according to claim 1.

9. The use of the fluorescent powder capable of promoting plant growth according to claim 8, wherein the fluorescent powder is used in promoting growth of tomatoes and growth of chlorellas; and when the fluorescent powder is used in promoting growth of tomatoes, the fluorescent powder is prepared into a light conversion film by a preparation method in the prior art, at least two light conversion films are evenly arranged around bottoms of tomato plants, and an intersect angle between the light conversion film and the horizontal plane is 0-60°.

10. The use of the fluorescent powder capable of promoting plant growth according to claim 9, wherein the intersect angle between the light conversion film and the horizontal plane is 20-60°.

11. The fluorescent powder capable of promoting plant growth according to claim 2, wherein when the fluorescent powder is used, the fluorescent powder is prepared into a light conversion film with resin, a reflection film is arranged below the light conversion film, and a system composed of the reflection film and the light conversion film is capable of converting sunlight into red light.

12. The fluorescent powder capable of promoting plant growth according to claim 3, wherein when the fluorescent powder is used, the fluorescent powder is prepared into a light conversion film with resin, a reflection film is arranged below the light conversion film, and a system composed of the reflection film and the light conversion film is capable of converting sunlight into red light.
